(19) United States
(12) Patent Application Publication
(10) Pub. No.: US 2024/0346552 A1
(43) Pub. Date: Oct. 17, 2024

(54) METHODS AND SYSTEMS FOR PROVIDING CONTENT

(71) Applicant: Comcast Cable Communications, LLC, Philadelphia, PA (US)

(72) Inventors: Arfeen Khalid, Oviedo, FL (US); Ehsan Younessian, Philadelphia, PA (US)

(21) Appl. No.: 18/300,730

(22) Filed: Apr. 14, 2023

(51) Int. Cl. G06Q 30/0251

(52) U.S. Cl. CPC G06Q 30/0254; G06Q 30/0255

(57) ABSTRACT

Reaction information and intensity information associated with primary content and secondary content may be determined. Secondary content may be selected based on the reaction information and the intensity information.

### BACKGROUND

Content may include primary content and secondary content. The subject of the primary content and the secondary content may be very different. This can cause conflicts when, for example, a user, while watching a romantic movie, receives a funny advertisement. The advertisement may, in itself, be unobjectionable to the user, but the conflicting sentiments between the movie and the advertisement can create feelings of discomfort or other undesirable emotions in a user and perhaps an aversion to what is being advertised. Thus, this is a need for more information about the secondary content surrounding primary content and more control over secondary content placement.

### SUMMARY

It is to be understood that both the following general description and the following detailed description are exemplary and explanatory only and are not restrictive. In some aspects, provided are methods and systems for targeted content delivery. Content, such as video and/or audio, can be analyzed to determine associated emotions or sentiments. Additional content, such as advertisements, can be determined for output before or after the content based on a similarity or difference between the emotions/sentiments associated with the content and the emotions/sentiments associated with the additional content. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating various aspects of an example system;

FIGS. 2A-2D illustrates example content;

FIGS. 3A-3B illustrate example diagrams;

FIG. 4 is a diagram illustrating an example system;

FIG. 5 is a flowchart illustrating an example method;

FIGS. 6A-6B are flowcharts illustrating example methods;

FIG. 7 is a flowchart illustrating an example method;

FIG. 8 is a flowchart illustrating an example method;

FIG. 9 is a flowchart illustrating an example method; and

FIG. 10 is a block diagram illustrating an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

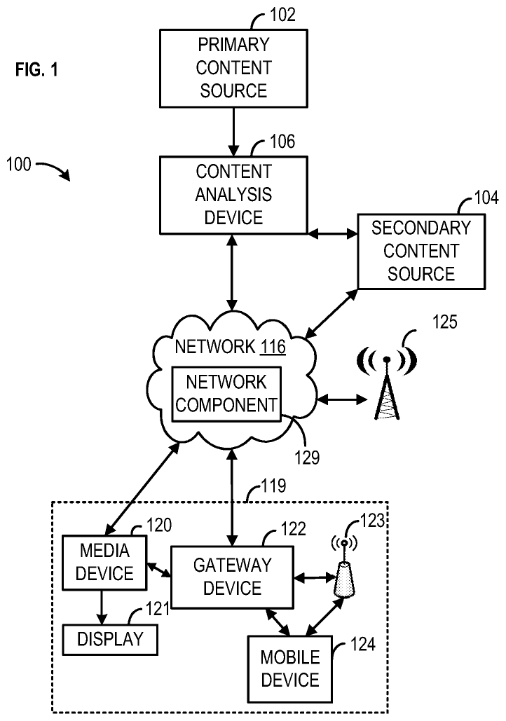

The present disclosure relates to methods and systems for delivering and managing content. FIG. 1 shows a system 100 for content distribution. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a primary content source 102, a secondary content source 104, a content analysis device 106, a media device 120, a gateway device 122, and/or a mobile device 124. Each of the primary content source 102, the secondary content source 104, the media device 120, the gateway device 122, and/or the mobile device 124, can be one or more computing devices, and some or all of the functions performed by these components may at times be performed by a single computing device. The primary content source 102, the secondary content source 104, the content analysis device 106, the media device 120, the gateway device 122, and/or the mobile device 124 may be configured to communicate through a network 116. The network 116 may facilitate sending content to and from any of the one or more device described herein. For example, the network may be configured to facilitate the primary content source 102 and/or the secondary content source 104 sending primary content and/or secondary content to one or more of the media device 120, the gateway device 122, and/or the mobile device 124.

The network 116 may be a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like. The network component 129 may be any device, module, combinations thereof, and the like communicatively coupled to the network 116. The network component 129 may also be a router, a switch, a splitter, a packager, a gateway, an encoder, a storage device, a multiplexer, a network access location (e.g., tap), physical link, combinations thereof, and the like.

The primary content source 102 may be configured to send content (e.g., video, audio, movies, television, games, applications, data, etc.) to one or more devices such as the content analysis device 106, the media device 120, a network component 129, a first access point 123, a mobile device 124, a second access point 125, and/or the media device 120. The primary content source 102 may be configured to send streaming media, such as broadcast content, video on-demand content (e.g., VOD), content recordings, combinations thereof, and the like. For example, the primary content source 102 may be configured to send primary content, via the network 116, to the media device 120.

The primary content source 102 may be managed by third party content providers, service providers, online content providers, over-the-top content providers, combinations thereof, and the like. The content may be sent based on a subscription, individual item purchase or rental, combinations thereof, and the like. The primary content source 102 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The secondary content source 104 may be configured to send content (e.g., video, audio, movies, television, games, applications, data, etc.) to one or more devices such as the media device 120, the gateway device 122, the network component 129, the first access point 123, the mobile device 124, and/or a second access point 125. The secondary content source 104 may comprise, for example, a content server such as an advertisement server. The secondary content source 104 may be configured to send secondary content. Secondary content can comprise, for example, advertisements (interactive and/or non-interactive) and/or supplemental content such as behind-the-scenes footage or other related content, supplemental features (applications and/or interfaces) such as transactional applications for shopping and/or gaming applications, metadata, combinations thereof, and the like. The metadata may comprise, for example, demographic data, pricing data, timing data, configuration data, combinations thereof, and the like. For example, the configuration data may include formatting data and other data related to delivering and/or outputting the secondary content.

The secondary content source 104 may be configured to send streaming media, such as broadcast content, video on-demand content (e.g., VOD), content recordings, combinations thereof, and the like. The secondary content source 104 may be managed by third party content providers, service providers, online content providers, over-the-top content providers, combinations thereof, and the like. The content may be sent based on a subscription, individual item purchase or rental, combinations thereof, and the like. The secondary content source 104 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The content analysis device 106 may be configured to receive, send, store, or process primary content and secondary content. The content analysis device 106 may be configured to determine reaction information, one or more valence metrics, intensity information one or more intensity metrics, one or more dominance metrics, one or more sentiment scores, combinations thereof, and the like.

The content analysis device 106 may be configured to receive primary content, analyze the primary content, and determine first reaction information associated with the primary content one or more first valence metrics associated with the primary content, intensity information associated with the primary content one or more first intensity metric associated with the primary content, one or more first dominance metrics associated with the primary content, and/or one or more first sentiment scores associated with the primary content. The content analysis device may determine first audio data associated with the primary content, first text data associated with the primary content, first image data associated with the primary content, first metadata associated with the primary content, combinations thereof, and the like.

The content analysis device 106 may be configured to receive secondary content, analyze the primary content, and determine second reaction information, one or more second valence metrics associated with the secondary content, second intensity information, one or more second intensity metric associated with the secondary content, one or more second dominance metrics associated with the secondary content, and/or one or more second sentiment scores associated with the secondary content. The content analysis device may determine first audio data associated with the secondary content, second text data associated with the secondary content, second image data associated with the secondary content, second metadata associated with the secondary content, combinations thereof, and the like.

The content analysis device 106 may be configured to compare a first sentiment score associated with the primary content to one or more second sentiment scores associated with one or more segments of secondary content. The content analysis device 106 may be configured to determine, select, recommend and/or output the one or more segments of secondary content based on a relationship between the one or more second sentiment scores associated with the one or more segments of secondary content and the first sentiment score associated with the primary content.

The media device 120 may be configured to receive the primary content. The media device 120 may comprise a device configured to enable an output device (e.g., a display, a television, a computer or other similar device) to output media (e.g., content). For example, the media device 120 may be configured to receive, decode, transcode, encode, send, and or otherwise process data and send data to, for example, the display device 121. The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via the gateway device 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the gateway device 122, a computer, a TV, a monitor, or a satellite dish. The gateway device 122 may be located at the premises 119. The gateway device 122 may send the content to the media device 120.

The gateway device 122 may comprise a local gateway (e.g., router, modem, switch, hub, combinations thereof, and the like) configured to connect (or facilitate a connection between) a local area network (e.g., a LAN) to a wide area network (e.g., a WAN) such as the network 116. The gateway device 122 may be associated with the premises 119. The gateway device may configured to receive incoming data (e.g., data packets or other signals) from the network 116 and route the data to one or more other devices associated with the premises 116 (e.g., the mobile device 124, the media device 120, the display 121, the access point 123, combinations thereof, and the like. The gateway device 122 may be configured to communicate with the network 116. The gateway device 122 may be a modem (e.g., cable modem), a router, a gateway, a switch, a network terminal (e.g., optical network unit), combinations thereof, and the like. The gateway device 122 may be configured for communication with the network 116 via a variety of protocols, such as IP, transmission control protocol, file transfer protocol, session initiation protocol, voice over IP (e.g., VOIP), combinations thereof, and the like. The gateway device 122, for a cable network, may be configured to facilitate network access via a variety of communication protocols and standards, such as Data Over Cable Service Interface Specification (DOCSIS).

The gateway device 122 may be configured to cause an upstream device to send, to the media device 120, the requested content. For example, the gateway device may send, to the secondary content source 104, an address and/or identifier associated with the media device 120 and cause the secondary device 104 to send the secondary content to the media device 120 via the network 116 or another network (e.g., if the media device 120 is connected to one or more networks).

A first access point 123 (e.g., a wireless access point) may be located at the premises 119. The first access point 123 may be configured to provide one or more wireless networks in at least a portion of the premises 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the gateway device 122, the media device 120, and the display device 121 may be implemented as a single device.

The premises 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

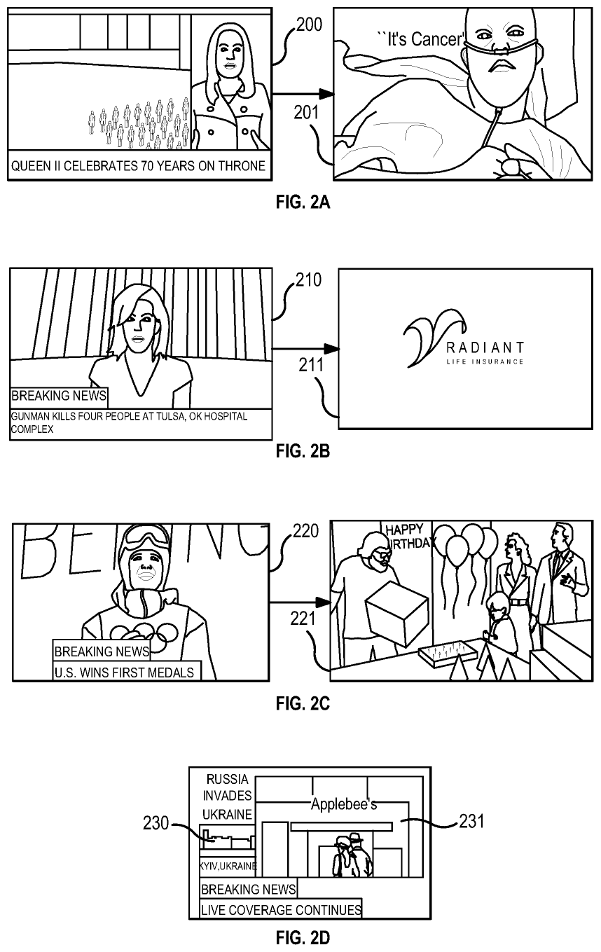

FIG. 2A shows an example of a sentiment misalignment between primary content 200 and secondary content 201. In the example, the primary content 200 may have a positive sentiment score. For example, happy reaction information (e.g., a happy valence metric) may be determined based on optical character recognition detecting “celebrates” in the headline. Further, audio data associated with the primary content 200 may be determined. The audio data associated with the primary content 200 may include, for example, trumpets blaring, bells ringing, etc. . . . . Further, the news anchor's speech may be analyzed to determine a tone. Further, the present systems and methods may perform facial analysis to determine sentiment of faces. For example, the news anchor's facial expressions may be analyzed to determine she is smiling or excited. Thus, the primary content 200 may be associated with a generally positive sentiment score. For example, facial detection may be performed on the primary content. The system may extract one or more facial features such as eyes, nose, mouth, eyebrows, combinations thereof, and the like. The system may determine and analyze one or more expressions such as smiles, frowns, eyebrow raises, looks of shock or surprise, sadness, combinations thereof, and the like. Expression analysis is the process of identifying and interpreting facial expressions by analyzing the movements and positioning of specific facial features such as the eyes, eyebrows, mouth, and nose. Facial expressions are a primary means of nonverbal communication, and they can convey a wide range of emotions, intentions, and attitudes. Expression analysis may involve using computer vision and machine learning algorithms to detect and track the movement and positioning of these facial features in real-time. This analysis can help to identify specific expressions such as a smile, frown, raised eyebrows, or wrinkled nose, and can also indicate the intensity of the expression. By analyzing facial expressions, expression analysis can provide insight into a person's emotional state, level of engagement, and overall mood.

Various machine learning algorithms can be used for determining the emotion behind the expression in facial analysis. Convolutional neural networks (CNNs) may be used in facial analysis tasks such as face detection, facial feature extraction, and expression analysis. They can be trained on large datasets of labeled images to learn to recognize patterns in facial expressions and link them to specific emotions. Support vector machines (SVMs) are a type of supervised learning algorithm that can be used to classify facial expressions into specific emotions based on features extracted from the image or video. SVMs work by finding the best hyperplane that separates the different classes of expressions.

Random forests are an ensemble learning method that can be used to classify facial expressions by training multiple decision trees on different subsets of the data. Random forests can be used for both classification and regression tasks.

Recurrent neural networks (RNNs may be used in time-series analysis tasks such as speech recognition and natural language processing. They can be used in facial analysis to model the temporal dynamics of facial expressions and link them to specific emotions over time. Deep belief networks (DBNs) are a type of unsupervised learning algorithm that can be used to learn hierarchical representations of facial expressions and link them to specific emotions. DBNs are particularly useful for analyzing complex and high-dimensional data such as facial expressions.

The secondary content 201 may be associated with a second sentiment score. The secondary content may be analyzed to determine a second sentiment score. The second sentiment score may be determined based on second reaction information and/or a second valence metric associated with the secondary content 201 and intensity information (e.g., a second intensity metric) associated with the secondary content 201. For example, facial recognition may determine the subject of the primary content is frowning. For example, image analysis may determine the colors of the secondary content 201 are in grey scale. For example, optical character recognition may detect the word “cancer,” in the caption. Further, audio data associated with the secondary content 201 may be determined. The audio data associated with the secondary content 200 may include, for example, sad music. For example, sad music may have characteristics such as a slow tempo, a minor key, a melancholic melody, low-pitched instruments, or soft dynamics. Sad music tends to be slow and somber, with a relaxed or even lethargic tempo. Slow tempos can create a sense of gravity and weight, emphasizing the emotional weight of the music. Sad music often uses the minor key, which is associated with melancholy and sadness. The minor key has a darker and more somber sound compared to the major key, which is associated with happiness and joy. The melody of sad music often has a melancholic or mournful quality, with long, slow notes and repetitive phrases. The melody may be simple and repetitive, emphasizing the emotional weight of the music. Sad music may use low-pitched instruments such as cellos, violas, and basses, which have a warm and somber sound. These instruments can create a sense of depth and weight, emphasizing the emotional intensity of the music. Sad music often uses soft dynamics, with quiet and delicate playing that creates a sense of intimacy and vulnerability. Soft dynamics can also create a sense of distance and detachment, emphasizing the emotional distance between the listener and the music.

The transition from happy primary content 200 to sad secondary content 201 may be jarring for users, causing users to tune away from the secondary content in search of happier content.

FIG. 2B shows an example of sentiment alignment between primary content 210 and secondary content 211. For example, the methods described herein may determine a first sentiment score associated with the primary content 210 and a second sentiment score associated with the secondary content 211. For example, the first sentiment score may be determined based on OCR detection of “gunman,” “kills,” and “hospital” in the caption of the news clip. Death in a news clip may make viewers feel contemplative or depressed. The secondary content 211, an advertisement for life insurance, may elicit similar feelings in viewers and thus create a smooth emotional transition between the primary content 210 and the secondary content 211.

FIG. 2C shows an example of sentiment alignment between primary content 220 and secondary content 221. A first sentiment score associated with the primary content 220 and a second sentiment score associated with the secondary content 221 may be determined. The first sentiment score may be determined based on audio data, text data, and image data associated with the primary content. For example, the athlete's smile may be detected by facial recognition and analysis techniques. For example, “wins” and “medal” and “bring home silver in Beijing” may be detected and determined to be associated with positive emotions. Similarly, secondary content 221 may be analyzed and the second sentiment score associated with the secondary content 221 may be determined. For example, audio analysis may detect laughter and clapping in an audio track associated with the secondary content 221. Text data may be determined via OCR to determine “Happy Birthday” in the background of the image of the secondary content 221. In FIG. 2C, the secondary content may be selected and output because the second sentiment score is similar to the first sentiment score.

FIG. 2D shows an example where primary content and secondary content are output at the same time. In FIG. 2C, the primary content 201 is a news broadcast covering the Russian invasion of Ukraine and the second content 201 is an advertisement for APPLEBEE'S®. This scenario may cause viewers to experience conflicting feelings (e.g., sadness or fear about the war and perhaps guilt about dining out while a war is going on).

The primary content is a news broadcast describing the Russian invasion of Ukraine. News coverage of an invasion may be associated with a first sentiment score.

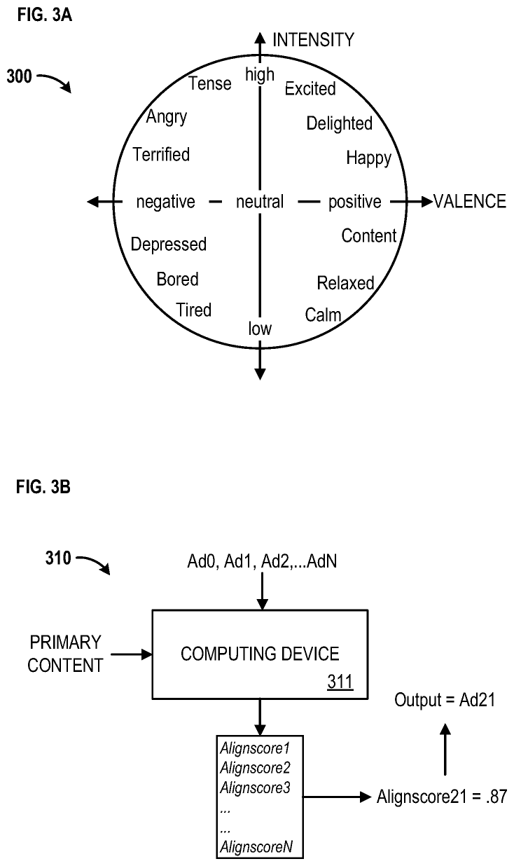

FIG. 3A shows an example diagram 300. The diagram 300 shows an example relationship between valence metrics and intensity metrics (e.g., reaction information and intensity information). Valence metrics may indicate how an audience (e.g., a user) may react to content (e.g., reaction information). A sentiment score may be determined based on one or more valence metrics (e.g., reaction information) and one or more intensity metrics. FIG. 3A shows a two dimensional model for modeling valence and intensity. The Valence axis indicates how pleasant (vs. unpleasant) the emotion is; the Intensity axis indicates how high (or low) the physiological intensity of the emotion is. Other models may be used such as the Valence-Arousal-Dominance (VID) model for representing emotions in a continuous space on a 3D plane with independent axes for valence, intensity, and dominance values. In a 3D model, a dominance axis may indicate how much the emotion is tied to the assertion of high (vs. low) social status. A combination of values picked from each axis may represent a categorical emotion like ‘angry’ or ‘sad’, much like how an (x, y, z) point represents a physical location in 3-D Euclidean space. Various transformations may be used to map discrete emotion labels to the VID space. The aforementioned 2D and 3D examples are merely exemplary and explanatory only and are not intended to be limiting. Any number of degrees or dimensions, axis, orders, magnitudes, directions, combinations thereof, and the like may be implemented.

FIG. 3B shows an example system 310. The system may comprise a computing device 311. The computing device 311 may be configured to receive primary content (e.g., a movie, a show, a news segment, combinations thereof, and the like). The computing device 311 may be configured to receive secondary content (e.g., one or more advertisements, one or more banner ads, supplemental content, one or more applications, combinations thereof, and the like). The system 310 may be configured to determine one or more content alignment scores. The one or more alignment scores may indicate a relationship between a first sentiment score associated with the primary content and one or more second sentiment scores associated with one or more pieces of secondary content. For example, the first sentiment score associated with the primary content may be determined based on a concatenation of a multidimensional valence vector associated with the primary content and a multidimensional intensity vector associated with the primary content.

Similarly, a second sentiment score of the one or more second sentiment scores may be determined based on a concatenation of a multidimensional valence vector associated with the secondary content and a multidimensional intensity vector associated with the secondary content. The content alignment score may indicate a relationship between the first sentiment score and the second sentiment score. For example, the content alignment score may represent a difference between the first sentiment score and the second sentiment score. The aforementioned is a simple example. It is to be understood that the content alignment score may represent any relationship between the first sentiment score (and/or constituents thereof such as the reaction information, the first valence metric and/or first intensity metric) and the second sentiment score (and/or constituents thereof such as the second reaction information/second valence metric and/or second intensity metric).

For example, secondary content can be recommend and/or output based on the content alignment score. For example, secondary content can be selected for output that minimizes the content alignment score (e.g., the first sentiment score and the second sentiment score are that different). Additionally and/or alternatively, secondary content can be recommend and/or output that maximizes the content alignment score (e.g., the primary content and the secondary content are associated with very different sentiment scores) and thus the sentiment of the secondary content may be quite difference than the sentiment of the primary content.

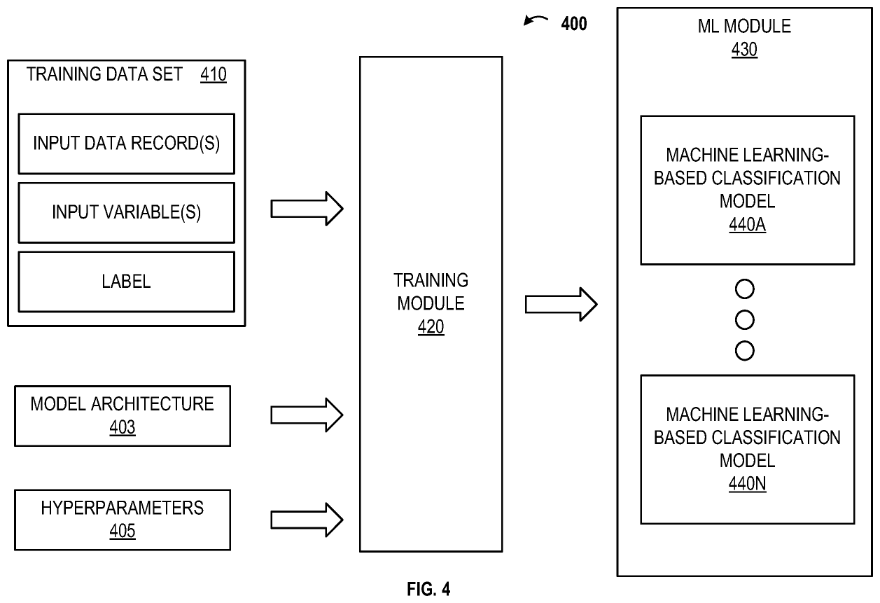

Turning now to FIG. 4, an example method 400 is shown. The method 400 may be performed based on an analysis of one or more training data sets 410 by a training module 420, at least one ML module 430 that is configured to provide one or more of a prediction or a score associated with data records and one or more corresponding variables. The training module 420 may be configured to train and configure the ML module 430 using one or more hyperparameters 405 and a model architecture 403. The one or more hyperparameters 405 may include audio segment duration, text segment duration, combinations thereof, and the like. The model architecture 403 may comprise a predictive model as described herein. The hyperparameters 405 may comprise a number of neural network layers/blocks, a number of neural network filters (e.g., convolutional filters) in a neural network layer, a number of epochs etc. For text features, a transformer-based encoder model may be used. For audio features, one or more CNN based models may be used. Each set of the hyperparameters 405 may be used to build the model architecture 403, and an element of each set of the hyperparameters 405 may comprise a number of inputs (e.g., data record attributes/variables) to include in the model architecture 403. For example, the first set of hyperparameters may be associated with a first model. The first model may be associated with a first task (e.g., a source task). The first task may comprise population level analysis. The second set of hyperparameters may be associated with a second model. The second model may be associated with a second task (e.g., the target task). In other words, an element of each set of the hyperparameters 405 may indicate that as few as one or as many as all corresponding attributes of the data records and variables are to be used to build the model architecture 403 that is used to train the ML module 430.

The training data set 410 may comprise one or more input data records associated with one or more labels (e.g., a binary label (yes/no, hypo/non-hypo), a multi-class label (e.g., hypo/non/hyper) and/or a percentage value). For example, a music model may be trained on 527 sound classes, 20 may be selected that are focused on different music genres (e.g., hip hop, rock, heavy metal, pop, ambient, combinations thereof, and the like). For example, a speech module may be trained on four speech tone classes (e.g., happy, sad, angry, neutral). For example, a text model may be trained in an unsupervised manner (e.g., without any labelled training data). The label for a given record and/or a given variable may be indicative of a likelihood that the label applies to the given record. A subset of the data records may be randomly assigned to the training data set 410 or to a testing data set. In some implementations, the assignment of data to a training data set or a testing data set may not be completely random. In this case, one or more criteria may be used during the assignment. In general, any suitable method may be used to assign the data to the training or testing data sets, while ensuring that the distributions of yes and no labels are somewhat similar in the training data set and the testing data set.

The training module 420 may train the ML module 430 by extracting a feature set from a plurality of data records (e.g., labeled as yes, hypo/hyper, no for normo) in the training data set 410 according to one or more feature selection techniques. For example, text-based and audio-based features may be extracted which describe the sentiment present in an input content. The sentiment may be expressed in the form of a valence or intensity vector. The training module 420 may train the ML module 430 by extracting a feature set from the training data set 410 that includes statistically significant features of positive examples (e.g., labeled as being yes) and statistically significant features of negative examples (e.g., labeled as being no).

The training module 420 may extract a feature set from the training data set 410 in a variety of ways. The training module 420 may perform feature extraction multiple times, each time using a different feature-extraction technique. In an example, the feature sets generated using the different techniques may each be used to generate different machine learning-based classification models 440A-440N. For example, the feature set with the highest quality metrics may be selected for use in training. The training module 420 may use the feature set(s) to build one or more machine learning-based classification models 440A-440N that are configured to indicate whether a particular label applies to a new/unseen data record based on its corresponding one or more variables.

The training data set 410 may be analyzed to determine any dependencies, associations, and/or correlations between features and the yes/no labels in the training data set 410. For example, a silence audio class may be associated with no audible sound. For example, a sine wave audio class may be associated with an instance when there is constant high-pitched sound (e.g., a beep). The identified correlations may have the form of a list of features that are associated with different yes/no labels. The term “feature,” as used herein, may refer to any characteristic of an item of data that may be used to determine whether the item of data falls within one or more specific categories. A feature selection technique may comprise one or more feature selection rules. The one or more feature selection rules may comprise a feature occurrence rule. The feature occurrence rule may comprise determining which features in the training data set 410 occur over a threshold number of times and identifying those features that satisfy the threshold as candidate features.

Two commonly-used retraining approaches are based on initialization and feature extraction. In the initialization approach the whole network is further trained, while in the feature extraction approach the last few fully-connected layers are trained from a random initialization, and other layers remain unchanged. In addition to these two approaches, a third approach may be implemented by combining these two approaches (e.g., the last few fully-connected layers are further trained, and other layers remain unchanged).

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training data set 410 to generate a first list of features. A final list of candidate features may be determined, generated, and/or analyzed according to additional feature selection techniques to determine one or more candidate feature groups (e.g., groups of features that may be used to predict whether a label applies or does not apply). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., yes/no).

As another example, one or more candidate feature groups may be selected according to a wrapper method. A wrapper method may be configured to use a subset of features and train a machine learning model using the subset of features. Based on the inferences that drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature groups. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature groups. Backward elimination is an iterative method that begins with all features in the machine learning model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside (e.g., includes and/or excludes) the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate one or more machine learning-based classification models 440A-440N based on the feature set(s). A machine learning-based classification model may refer to a complex mathematical model for data classification that is generated using machine-learning techniques. In one example, the machine learning-based classification model 440 may include a map of support vectors that represent boundary features. By way of example, boundary features may be selected from, and/or represent the highest-ranked features in, a feature set. The boundary features may be configured to separate or classify data points into different categories or classes. The boundary features may be configured to determine, for example, valence metrics and intensity metrics of content.

The training module 420 may use the feature sets extracted from the training data set 410 to build the one or more machine learning-based classification models 440A-440N for each classification category (e.g., yes, no, hypo/non, hypo/non/hyper). In some examples, the machine learning-based classification models 440A-440N may be combined into a single machine learning-based classification model 440. Similarly, the ML module 430 may represent a single classifier containing a single or a plurality of machine learning-based classification models 440 and/or multiple classifiers containing a single or a plurality of machine learning-based classification models 440.

The extracted features (e.g., one or more candidate features) may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting ML module 430 may comprise a decision rule or a mapping for each candidate feature.

The candidate feature(s) and the ML module 430 may be used to predict whether a label applies to a data record in the testing data set. In one example, the result for each data record in the testing data set includes a confidence level that corresponds to a likelihood or a probability that the one or more corresponding variables are indicative of the label applying to the data record in the testing data set. The confidence level may be a value between zero and one, and it may represent a likelihood that the data record in the testing data set belongs to a yes/no status with regard to the one or more corresponding variables. In one example, when there are two statuses (e.g., yes and no), the confidence level may correspond to a value p, which refers to a likelihood that a particular data record in the testing data set belongs to the first status (e.g., yes). In this case, the value 1−p may refer to a likelihood that the particular data record in the testing data set belongs to the second status (e.g., no). In general, multiple confidence levels may be provided for each data record in the testing data set and for each candidate feature when there are more than two labels. A top performing candidate feature may be determined by comparing the result obtained for each test data record with the known yes/no label for each data record. In general, the top performing candidate feature will have results that closely match the known yes/no labels. The top performing candidate feature(s) may be used to predict the yes/no label of a data record with regard to one or more corresponding variables. For example, a new data record may be determined/received. The new data record may be provided to the ML module 430 which may, based on the top performing candidate feature, classify the label as either applying to the new data record or as not applying to the new data record.

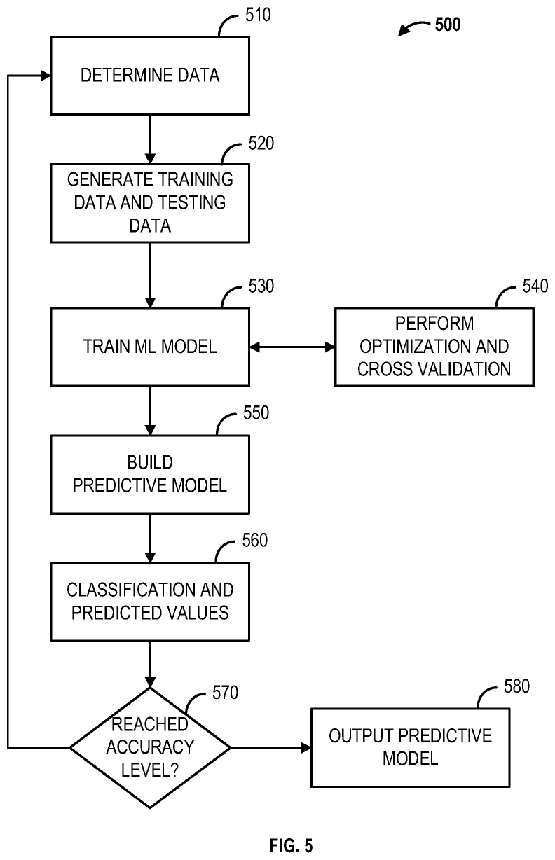

FIG. 5 shows a flowchart illustrating an example training method 500 for generating the ML module 430 using the training module 420 is shown. The training module 420 can implement supervised, unsupervised, and/or semi-supervised (e.g., reinforcement based) machine learning-based classification models 440A-440N. The training module 420 may comprise a data processing module and/or a predictive module. The method 500 illustrated in FIG. 5 is an example of a supervised learning method; variations of this example of training method are discussed below, however, other training methods can be analogously implemented to train unsupervised and/or semi-supervised machine learning models.

The training method 500 may determine (e.g., access, receive, retrieve, etc.) first data records that have been processed by the data processing module at step 510. The first data records may comprise a labeled set of data records. The labels may correspond to a label (e.g., yes or no). The training method 500 may generate, at step 520, a training data set and a testing data set. The training data set and the testing data set may be generated by randomly assigning labeled data records to either the training data set or the testing data set. In some implementations, the assignment of labeled data records as training or testing samples may not be completely random. As an example, a majority of the labeled data records may be used to generate the training data set. For example, 65% of the labeled data records may be used to generate the training data set and 55% may be used to generate the testing data set. The training data set may comprise population data that excludes data associated with a target patient.

The training method 500 may train one or more machine learning models at step 530. In one example, the machine learning models may be trained using supervised learning. In another example, other machine learning techniques may be employed, including unsupervised learning and semi-supervised. The machine learning models trained at 530 may be selected based on different criteria depending on the problem to be solved and/or data available in the training data set. For example, machine learning classifiers can suffer from different degrees of bias. Accordingly, more than one machine learning model can be trained at 530, optimized, improved, and cross-validated at step 540.

For example, a loss function may be used when training the machine learning models at step 530. The loss function may take true labels and predicted outputs as its inputs, and the loss function may produce a single number output. The present methods and systems may implement a mean absolute error, relative mean absolute error, mean squared error and relative mean squared error using the original training dataset without data augmentation.

One or more minimization techniques may be applied to some or all learnable parameters of the machine learning model (e.g., one or more learnable neural network parameters) in order to minimize the loss. For example, the one or more minimization techniques may not be applied to one or more learnable parameters, such as encoder modules that have been trained, a neural network block(s), a neural network layer(s), etc. This process may be continuously applied until some stopping condition is met, such as a certain number of repeats of the full training dataset and/or a level of loss for a left-out validation set has ceased to decrease for some number of iterations. In addition to adjusting these learnable parameters, one or more of the hyperparameters 405 that define the model architecture 403 of the machine learning models may be selected. The one or more hyperparameters 405 may comprise a number of neural network layers, a number of neural network filters in a neural network layer, etc. For example, as discussed above, each set of the hyperparameters 405 may be used to build the model architecture 403, and an element of each set of the hyperparameters 405 may comprise a number of inputs (e.g., data record attributes/variables) to include in the model architecture 403. The element of each set of the hyperparameters 405 comprising the number of inputs may be considered the “plurality of features” as described herein. That is, the cross-validation and optimization performed at step 540 may be considered as a feature selection step. An element of a second set of the hyperparameters 505 may comprise data record attributes for a particular patient. In order to select the best hyperparameters 405, at step 540 the machine learning models may be optimized by training the same using some portion of the training data (e.g., based on the element of each set of the hyperparameters 405 comprising the number of inputs for the model architecture 403). The optimization may be stopped based on a left-out validation portion of the training data. A remainder of the training data may be used to cross-validate. This process may be repeated a certain number of times, and the machine learning models may be evaluated for a particular level of performance each time and for each set of hyperparameters 405 that are selected (e.g., based on the number of inputs and the particular inputs chosen).

A best set of the hyperparameters 405 may be selected by choosing one or more of the hyperparameters 405 having a best mean evaluation of the “splits” of the training data. This function may be called for each new data split, and each new set of hyperparameters 405. A cross-validation routine may determine a type of data that is within the input (e.g., attribute type(s)), and a chosen amount of data (e.g., a number of attributes) may be split-off to use as a validation dataset. A type of data splitting may be chosen to partition the data a chosen number of times. For each data partition, a set of the hyperparameters 405 may be used, and a new machine learning model comprising a new model architecture 403 based on the set of the hyperparameters 405 may be initialized and trained. After each training iteration, the machine learning model may be evaluated on the test portion of the data for that particular split. The evaluation may return a single number, which may depend on the machine learning model's output and the true output label. The evaluation for each split and hyperparameter set may be stored in a table, which may be used to select the optimal set of the hyperparameters 405. The optimal set of the hyperparameters 405 may comprise one or more of the hyperparameters 405 having a highest average evaluation score across all splits.

The training method 500 may select one or more machine learning models to build a predictive model at 550. The predictive model may be evaluated using the testing data set. The predictive model may analyze the testing data set and generate one or more of a prediction or a score at step 560. The one or more predictions and/or scores may be evaluated at step 570 to determine whether they have achieved a desired accuracy level. Performance of the predictive model may be evaluated in a number of ways based on a number of true positives, false positives, true negatives, and/or false negatives classifications of the plurality of data points indicated by the predictive model.

For example, the false positives of the predictive model may refer to a number of times the predictive model incorrectly classified a label as applying to a given data record when in reality the label did not apply. Conversely, the false negatives of the predictive model may refer to a number of times the machine learning model indicated a label as not applying when, in fact, the label did apply. True negatives and true positives may refer to a number of times the predictive model correctly classified one or more labels as applying or not applying. Related to these measurements are the concepts of recall and precision. Generally, recall refers to a ratio of true positives to a sum of true positives and false negatives, which quantifies a sensitivity of the predictive model. Similarly, precision refers to a ratio of true positives a sum of true and false positives. When such a desired accuracy level is reached, the training phase ends and the predictive model (e.g., the ML module 430) may be output at step 580; when the desired accuracy level is not reached, however, then a subsequent iteration of the training method 500 may be performed starting at step 510 with variations such as, for example, considering a larger collection of data records.

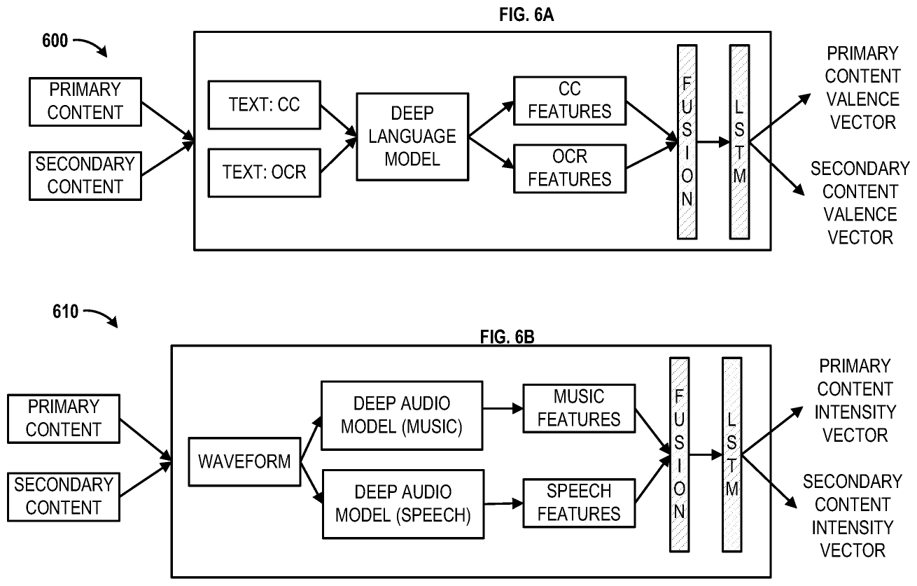

FIG. 6A shows an example system 600. In the system 600, primary content and secondary content can be received by the system 600. The system may be configured to determine and analyze text data associated with the primary content and the secondary content. The text data may comprise closed-caption data, on-screen text data (e.g., determined via optical character recognition or “OCR”), combinations thereof, and the like. The text data can be input to a deep language model. The deep language model may be configured to determine one or more features of the closed-caption data (e.g., closed-caption features) and/or the OCR data (e.g., OCR features). The deep language model may generate the closed-caption features and the OCR features and input them to the fusion layer. For example, the sequential fused features (e.g., closed-caption and OCR) may be input to the LSTM layer to capture temporal information. The deep language model may be an encoder-only transformer model trained on a large corpus of web data in an unsupervised manner. The DLM may use masked language modeling (MLM) as a learning objective. The DLM may be configured to predict masked words in input data. A fusion layer may be configured to concatenation that combines features generated from closed caption data and OCR. The fusion layer may fuse (e.g., concatenate) the closed-caption features and the OCR features. The fusion layer may be configured to combine one or inputs into a single representation. The fusion layer may be configured to extract relevant information from input sources (e.g., the CC features and OCR features) and create a new, more informative representation that can be used by the next layer of the network. The input sources may be combined via concatenation, element-wise addition or multiplication, neural attention mechanisms, combinations thereof, and the like. Fusion layers are often used in multi-modal deep learning models, where the input to the network consists of multiple modalities, such as images and text, and the fusion layer is used to combine the information from these modalities into a single representation for further processing.

The fused features may be passed to a long-short term memory model (LSTM model). The LSTM model may comprise a hidden layer. The hidden layer may comprise 100 units (e.g., 100 memory cells). Each memory cell has one or more states that can be updated based on input data and previous state information, and the hidden layer consists of multiple memory cells that work together to process sequential data. LSTMs are well-suited for processing sequential data. For example, each memory cell may have a hidden state (e.g., an overall state of what has been seen by the cell so far), and a cell state (e.g., a selective memory of the past). At each time step, the input may be transformed by a series of nonlinear transformations and weights in the LSTM cell. The hidden layer of LSTM (in our case) contains 100 such memory cells, each of which can selectively remember or forget information based on the input it receives.

The hidden layer may receive input from a previous state and input data and then may update the memory cell state using activation functions (e.g. sigmoid and tanh). The updated memory cell state is then used as input to the output layer, which produces the final output for the LSTM. The hidden layer also has gates (input, forget, and output gates) that control the flow of information into and out of the memory cell, allowing the LSTM to selectively retain or forget information as needed. The hidden layer may comprise one or more gates (input, forget, and output gates). The one or more gates may be configured to control the flow of information into and out of the memory cells, allowing the LSTM to selectively retain or forget information as needed. These gates are implemented as part of the LSTM memory cell in the hidden layer that receive input from the input data and the previous state and produce values used to update the memory cell state.

The system 600 may output one or more primary content valence vectors. The system 600 may output one or more secondary content valence vectors.

FIG. 6B shows an example system 610. The system 610 may be configured to receive (e.g., determine) primary content and secondary content. The system 610 may be configured to receive (e.g., determine) audio data. The system 610 may be configured to determine one or more waveforms. For example, the system 610 may be configured to determine the one or more waveforms based on the audio data. The audio data may be input to a deep audio model configured to music. The deep audio model configured for music may output (e.g., determine, generate) one or more music features. The music features may be input to a fusion layer.

The audio data may be input to a deep audio model configured for speech. The deep audio model configured for speech may output (e.g., determine, generate) one or more speech features. The speech features may be input to the fusion layer.

The fusion layer may fuse the music features and the speech features. The fused music features and speech features may be input to an LSTM model comprising one hidden layer (e.g., 100 units). The system 610 may output one or more primary content intensity vectors. The system 610 may output one or more secondary content intensity vectors.

The systems 600 and 610 may, alone or in combination, output a combined-weighted vector. The combined-weighted vector may combine both valence and intensity metrics using a weighted mechanism depending on a content type. For example, a valence metric may be weighted more heavily for primary content (e.g., movies, news, television, etc. . . . ). For example, for news, the combined-weighted vector may be:

$$News = {n\_w}^{( val )} {News}^{( val )} + {n\_w}^{( int )} {News}^{( int )}$$

For example, an intensity metric may be weighted more heavily for secondary content (e.g., advertisements). For example, for advertisements, the combined-weighted vector may be:

$$Ad = {a\_w}^{( val )} {Ad}^{( val )} + {a\_w}^{( int )} {Ad}^{( int )}$$

The systems 600 and 610 may, alone or in combination, output a content alignment score. The content alignment score may be configured to indicate how similar the sentiment scores of one or more segments of content (e.g., either or both primary content and secondary content). For example, for given primary content and secondary content (e.g., News and Adᵢ∈{Ad₀, Ad₁, . . . . Ad_{N}}) the content alignment score may be:

$${alignscore}_{i} = cos\_sim ( News , {Ad}_{i} )$$

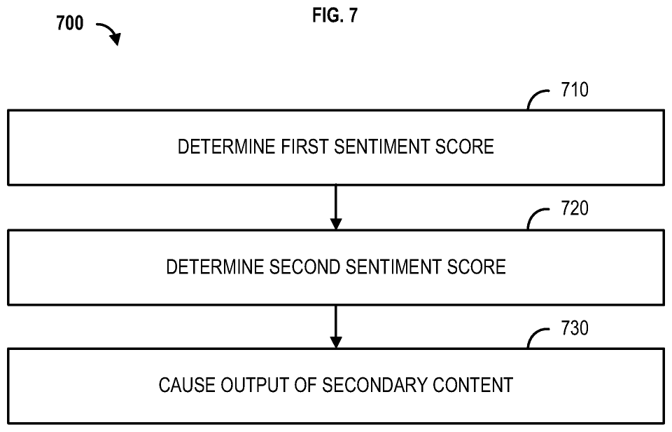

FIG. 7 shows an example method 700. The method 700 may be carried out via one or more of the devices described herein. At 710, a first sentiment score associated with primary content may be determined. The first sentiment score associated with the primary content may be based on reaction information (e.g, a valence metric) and intensity information (e.g., an intensity metric). The reaction information may be determined based on text data associated with primary content. The text data may comprise closed-caption data, on-screen text (e.g., determined via optical character recognition or “OCR”), metadata, combinations thereof, and the like.

The reaction information may indicate how positive or negative the one or more primary content segments are. For example, a first reaction information may indicate a first segment of primary content is happy (e.g., may make a user feel happy, expresses traditionally happy situations such as birthday parties and weddings). For example, a second reaction information may indicate a second segment of primary content is sad (e.g., may make the user feel sad, depressed, expresses or depicts traditionally sad situations like war, a medical diagnosis, or a funeral). For example, either or both of the first reaction information or the second reaction information may comprise a 100-D (one hundred dimensional) vector obtained from the LSTM's hidden layer. In determining the reaction information, a deep language model may be used to generate features for closed caption data as well as on-screen text (e.g., via optical character recognition). Examples of on-screen text include banners, signs, posters, graffiti, or any other characters. A fusion layer may fuse the features obtained from the closed caption text and the features obtained from the on-screen text. The features resulting from the fusion may be passed to a long-short term memory (LSTM) model. The long-short term memory model may comprise one hidden layer (e.g., of 100 units) and be configured to capture temporal dependencies. The output from the LSTM model may the one or more valence scores. The reaction information may be a vector. Intensity information (e.g., an intensity metric) may be determined. The intensity information may be determined based on audio data associated with the primary content. The audio data may comprise data associated with, for example, music, spoken words (and/or characteristics thereof such as tone, context, syntax, or the like) or other audio in the primary content. The intensity information may be configured to indicate how intensely a given sentiment is expressed in the primary content. For example, the intensity intensity may comprise a 100-D (one hundred dimensional) vector obtained from the LSTM's hidden layer.

Determining the first sentiment score may comprise processing one or more of: closed caption data associated with the primary content, on screen text or graphics associated with the primary content, one or more optical characters associated with the primary content, one or more objects in the primary content, combinations thereof, and the like. The first sentiment score may comprise a concatenation of a multidimensional valence vector associated with one or more segments of primary content and a multidimensional intensity vector associated with the one or more segments of primary content, and wherein the second sentiment score comprises a concatenation of a multidimensional valence vector associated with one or more segments of secondary content and a multidimensional intensity vector associated with the one or more segments of secondary content.

At 720, one or more segments of secondary content may be determined. The one or more segments of secondary content may be determined based on the first sentiment score. The one or more segments of secondary content may be associated with one or more second sentiment scores. For example, each segment of secondary content of the one or more segments of secondary content may be associated with one or more second sentiment scores. Determining the secondary content may comprise selecting, from among one or more secondary content items, the secondary content associated with the second sentiment score closest to the first sentiment score. Each of the first sentiment score or the second sentiment score may comprise an embedded vector comprising an abstract latent representation which may or may not have a particular name or meaning. The dimensions of the vector may be configured to represent one or more characteristics of and audio track or video track of interest (e.g., music, speech, other audio, video data, object data, combinations thereof, and the like).

At 730, a segment of secondary content may be caused to be output. The segment of secondary content may be caused to be output based on a relationship between the first sentiment score and the second sentiment score. For example, the relationship between the first sentiment score and the second sentiment score may comprise one or more of a similarity or a difference.

The method may comprise receiving the primary content. The method may comprise sending the primary content. The method may comprise processing the primary content. The method may comprise receiving the one or more segments of secondary content. The method may comprise sending the one or more segments of secondary content. The method may comprise processing the one or more segments of secondary content. The method may comprise sending a request for the secondary content. The method may comprise receiving, based on the request for the secondary content, the requested secondary content. The method may comprise displaying the secondary content. The method may comprise receiving an indication that a user has navigated away from the secondary content. The method may comprise updating a sentiment profile associated with the user. The sentiment profile may be updated based on a user navigating away from the secondary content.

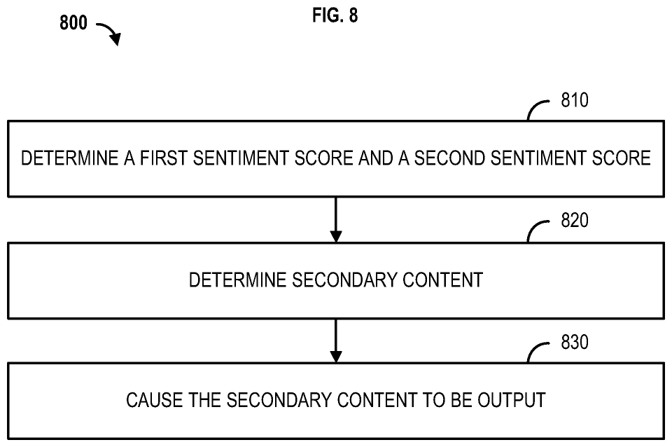

FIG. 8 shows an example method 800. The method 800 may be carried out via one or more of the devices described herein. At 810, a first sentiment score associated with a first portion of primary content and a second sentiment score associated with a second portion of primary content. The first sentiment score may represent a concatenation of one or more first valence metrics associated with the first portion of primary content and one or more first intensity metrics associated with the first portion of primary content. The one or more first valence metrics may be determined based on text data associated with the first portion of primary content. The one or more first intensity metrics may be determined based on audio data associated with the first portion of primary content. The second sentiment score may represent a concatenation of one or more second valence metrics associated with the second portion of primary content and one or more second intensity metric associated with the second portion of primary content. The one or more second valence metrics may be determined based on text data associated with the second portion of primary content. The one or more second intensity metrics may be determined based on audio data associated with the second portion of primary content.

At 820, secondary content may be determined. The secondary content may be determine based on the first sentiment score and the second sentiment score. For example, the secondary content may comprise one or more advertisements, supplemental content, supplement features, one or more applications, combinations thereof, and the like. The secondary content may be determined based on difference between the first sentiment score and the second sentiment score. For example, the secondary content may be associated with a third sentiment score. The third sentiment score may fall between the first sentiment score and the second sentiment score. Thus, the secondary content may be determined such that a user viewing the first portion of primary content, the secondary content, and the second portion of primary content will experience smooth emotional transitions between the first portion of primary content, the secondary content, and the second portion of primary content. Each of the first sentiment score, the second sentiment score, and the third sentiment score may comprise a concatenation of a multidimensional valence vector and a multidimensional intensity vector. Each of the first sentiment score, the second sentiment score, and the third sentiment score may comprise an embedded vector comprising an abstract latent representation which may or may not have a particular name or meaning. The dimensions of the vector may be configured to represent one or more characteristics of and audio track or video track of interest (e.g., music, speech, other audio, video data, object data, combinations thereof, and the like).

At 830, the secondary content may be caused to be output. For example, the secondary content may be caused to be output between the first portion of primary content and the second portion of primary content. Outputting the secondary content between the first portion of primary content and the second portion of primary content may comprise sending the secondary content to a media device to be inserted into a content stream between the first portion of primary content and the second portion of primary content. Outputting the secondary content between the first portion of primary content and the second portion of primary content may comprise causing the secondary content to be displayed after the first portion of primary content and before the second portion of primary content.

The method may comprise determining alternative secondary content. The method may comprise receiving an indication that a user has navigated away from the secondary content. The method may comprise updating a sentiment profile associated with a user and/or a user device.

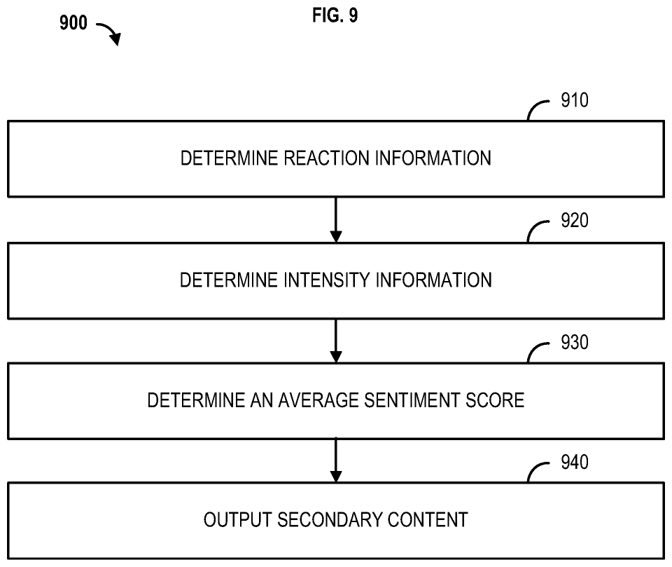

FIG. 9 shows an example method 900. The method 900 may be carried out via one or more of the devices described herein. At 910, one or more valence metrics may be determined. The one or more valence metrics may be associated with one or more segments of primary content. The one or more valence metrics may be determined based on text data associated with the primary content. The text data may comprise, for example, closed caption data, metadata, or other data associated with the one or more segments of primary content. The one or more valence metrics may indicate how positive or negative the one or more primary content segments are. For example, a first valence metric of the one or more valence metrics may indicate a first segment of primary content is happy (e.g., may make a user feel happy, expresses traditionally happy situations such as birthday parties and weddings). For example, a second valence metric of the one or more valence metrics may indicate a second segment of primary content is sad (e.g., may make the user feel sad, depressed, expresses or depicts traditionally sad situations like war, a medical diagnosis, or a funeral). In determining the one or more valence metrics, a deep language model may be used to generate features for closed caption data as well as on-screen text (e.g., via optical character recognition). Examples of on-screen text include banners, signs, posters, graffiti, or any other characters. A fusion layer may fuse the features obtained from the closed caption text and the features obtained from the on-screen text. The features resulting from the fusion may be passed to a long-short term memory (lstm) model. The long-short term memory model may comprise one hidden layer (e.g., of 100 units) and be configured to capture temporal dependencies. The output from the LSTM model may the one or more valence scores. The one or more valence scores may be vectors. The one or more valence scores may be 100-D vectors obtained from the LSTM's hidden layer. They may be configured to capture the temporal information of how valence/intensity changes during the duration of the input video.

At 920, intensity information (e.g., one or more intensity metrics) may be determined. The one or more intensity metrics may be associated with the one or more segments of primary content. The one or more intensity metrics may be configured to indicate how intensely a feeling (e.g., the one or more valence scores) is expressed in the one or more segments of primary content. The one or more intensity metrics may be determined based on audio data associated with the one or more segments of primary content. The audio data may comprise, for example, music, background noise, pitch, tone, or other features associated with spoken words, combinations thereof, and the like. One or more deep audio models may be used to determine (e.g., generate) one or more audio features based on music, speech, or other audio associated with the one or more segments of primary content. A fusion layer may fuse one or more features (e.g., music features and speaking features). The fused features may be sent to an LSTM model with one hidden layer (e.g., 100 units) to capture temporal dependencies. The output from the LSTM audio layer may be the one or more intensity scores. The one or more intensity scores may be vectors.

At 930, an average sentiment score associated with the one or more segments of primary content may be determined. The average sentiment score may comprise an average of one or more sentiment scores each associated with a segment of primary content of the one or more segments of primary content. The one or more sentiment scores and the average sentiment score may be determined based on the reaction information (e.g., one or more valence metrics) and the intensity information (e.g., one or more intensity metrics).

At 940, secondary content may be caused to be output. The secondary content may be output based on a correlation between the average sentiment score and a second sentiment score associated with the secondary content. For example, the secondary content may comprise an advertisement, supplemental content, one or more applications, combinations thereof, and the like. The correlation between the average sentiment score and the second sentiment score may be a content sentiment alignment score.

The method may comprise causing a media device to insert the secondary content into (e.g., in between) the one or more segments of primary content.

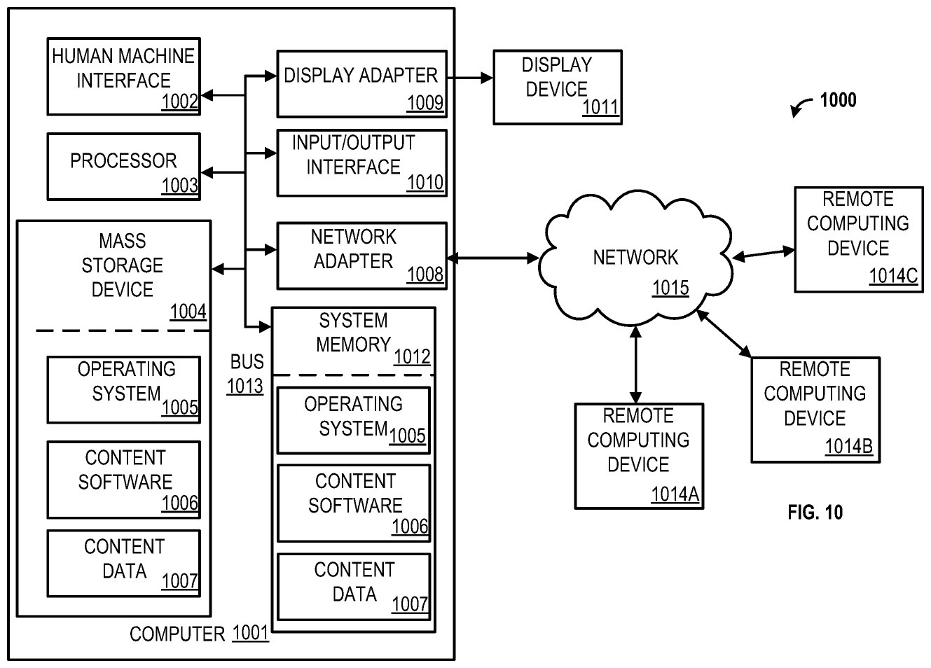

The methods and systems can be implemented on a computer 1001 as illustrated in FIG. 10 and described below. Similarly, the methods and systems disclosed can utilize one or more computers to perform one or more functions in one or more locations. FIG. 10 is a block diagram illustrating an example operating environment 1000 for performing the disclosed methods. This example operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the example operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage content including memory storage devices.

Further, one skilled in the art will appreciate that the systems and methods disclosed herein can be implemented via a general-purpose computing device in the form of a computer 1001. In an aspect, the computer 1001 can serve as the content provider. The computer 1001 can comprise one or more components, such as one or more processors 1003, a system memory 1012, and a bus 1013 that couples various components of the computer 1001 including the one or more processors 1003 to the system memory 1012. In the case of multiple processors 1003, the operating environment 1000 can utilize parallel computing.

The bus 1013 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, content software 1006, content data 1007, a network adapter 1008, system memory 1012, an Input/Output Interface 1010, a display adapter 1009, a display device 1011, and a human machine interface 1002, can be contained within one or more remote computing devices 1014A,B,C at physically separate locations, connected through buses of this form, in effect implementing a fully distributed system.

The computer 1001 typically comprises a variety of computer readable content. Example readable content can be any available content that is accessible by the computer 1001 and comprises, for example and not meant to be limiting, both volatile and non-volatile content, removable and non-removable content. The system memory 1012 can comprise computer readable content in the form of volatile memory, such as random access memory (RAM), and/or non-volatile memory, such as read only memory (ROM). The system memory 1012 typically can comprise data such as content data 1007 and/or program modules such as operating system 1005 and content software 1006 that are content accessible to and/or are operated on by the one or more processors 1003.

In another aspect, the computer 1001 can also comprise other removable/non-removable, volatile/non-volatile computer storage content. The mass storage device 1004 can provide non-volatile storage of computer code, computer readable instructions, data structures, program modules, and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, an operating system 1005 and content software 1006. The content data 1007 can also be stored on the mass storage device 1004. Content data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

In an aspect, the user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via a human machine interface 1002 that is coupled to the bus 1013, but can be connected by other interface and bus structures, such as a parallel port, game port, an IEEE 1394 Port (also known as a Firewire port), a serial port, network adapter 1008, and/or a universal serial bus (USB).

In yet another aspect, a display device 1011 can also be connected to the bus 1013 via an interface, such as a display adapter 1009. It is contemplated that the computer 1001 can have more than one display adapter 1009 and the computer 1001 can have more than one display device 1011. For example, a display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via Input/Output Interface 1010. Any step and/or result of the methods can be output in any form to an output device. Such output can be any form of visual representation, including, but not limited to, textual, graphical, animation, audio, tactile, and the like. The display 1011 and computer 1001 can be part of one device, or separate devices.

The computer 1001 can operate in a networked environment using logical connections to one or more remote computing devices 1014A,B,C. By way of example, a remote computing device 1014A,B,C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1001 and a remote computing device 1014A,B,C can be made via a network 1015, such as a local area network (LAN) and/or a general wide area network (WAN). Such network connections can be through a network adapter 1008. The network adapter 1008 can be implemented in both wired and wireless environments. Such networking environments are conventional and commonplace in dwellings, offices, enterprise-wide computer networks, intranets, and the Internet. In an aspect, the remote computing devices 1014A,B,C can serve as first and second devices for displaying content. For example, the remote computing device 1014A can be a first device for displaying portions of primary content, and one or more of the remote computing devices 1014B,C can be a second device for displaying secondary content. As described above, the secondary content is provided to the second device (e.g., one or more of the remote computing devices 1014B,C) in lieu of providing the secondary content to the first device (i.e., the remote computing device 1014A). This allows the first device to display multiple portions of primary content contiguously, without in-line breaks for secondary content.

For purposes of illustration, application programs and other executable program components such as the operating system 1005 are illustrated herein as discrete blocks, although it is recognized that such programs and components can reside at various times in different storage components of the computing device 1001, and are executed by the one or more processors 1003 of the computer 1001. An implementation of content software 1006 can be stored on or transmitted across some form of computer readable content. Any of the disclosed methods can be performed by computer readable instructions embodied on computer readable content. The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, based on reaction information associated with primary content and intensity information associated with the primary content, a first sentiment score associated with the primary content;
determining, based on the first sentiment score, one or more segments of secondary content, wherein each segment of secondary content of the one or more segments of secondary content is associated with one or more second sentiment scores; and
causing, based on a relationship between the first sentiment score and a second sentiment score of the one or more second sentiment scores, a segment of secondary content to be output.

2. The method of claim 1, wherein the first sentiment score comprises a concatenation of a multidimensional valence vector associated with one or more segments of primary content and a multidimensional intensity vector associated with the one or more segments of primary content, and wherein the second sentiment score comprises a concatenation of a multidimensional valence vector associated with the one or more segments of secondary content and a multidimensional intensity vector associated with the one or more segments of secondary content.

3. The method of claim 1, wherein determining the first sentiment score comprises processing one or more of: closed caption data associated with the primary content, on screen graphics associated with the primary content, one or more optical characters associated with the primary content, or one or more objects in the primary content.

4. The method of claim 1, wherein determining the one or more segments of secondary content comprises selecting, from among one or more secondary content items, one or more segments of secondary content associated with a second sentiment score closest to the first sentiment score.

5. The method of claim 1, wherein the relationship between the first sentiment score and the second sentiment score comprises one or more of a similarity or a difference.

6. The method of claim 1, wherein causing the one or more segments of secondary content to be output comprises:
sending a request for the one or more segments of secondary content;
receiving, based on the request for the one or more segments of secondary content, the one or more segments of secondary content; and
displaying the one or more segments of secondary content.

7. The method of claim 1, further comprising:
receiving an indication that a user has navigated away from the one or more segments of secondary content; and
based on the user navigating away from the secondary content, updating a sentiment profile associated with the user.

8. A method comprising:
determining, a first sentiment score associated with a first portion of primary content and a second sentiment score associated with a second portion of primary content;
determining, based on a difference between the first sentiment score and the second sentiment score, secondary content; and
causing the secondary content to be output between the first portion of primary content and the second portion of primary content.

9. The method of claim 8, wherein each of the first sentiment score and the second sentiment score comprise a concatenation of a multidimensional valence vector and a multidimensional intensity vector.

10. The method of claim 8, further comprising:
receiving an indication that a user has navigated away from the secondary content; and
based on the user navigating away from the secondary content, updating a sentiment profile associated with the user.

11. The method of claim 10, further comprising determining alternative secondary content by selecting the alternative secondary content from among one or more alternative secondary content items.

12. The method of claim 11, further comprising causing a media device to insert the alternative secondary content between the first portion of primary content and the second portion of primary content.

13. The method of claim 8, wherein a relationship between the first sentiment score and the second sentiment score comprises a first degree of similarity.

14. The method of claim 13, wherein the secondary content comprises one or more advertisements.

15. A method comprising:
determining, based on text data associated with one or more segments of primary content, reaction information associated with the one or more segments of primary content;
determining, based on audio data associated with the one or more segments of primary content, one or more intensity scores associated with the one or more segments of primary content;
determining, based on the reaction information and the one or more intensity scores, an average sentiment score associated with the one or more segments of primary content; and
based on a correlation between the average sentiment score and a second sentiment score associated with secondary content, causing output of the secondary content.

16. The method of claim 15, wherein the data associated with the one or more segments of primary content comprises one or more of text data, audio data, closed caption data, or metadata.

17. The method of claim 15, wherein the reaction information are configured to indicate how positive or negative the one or more segments of primary content are.

18. The method of claim 15, wherein the one or more intensity scores are configured to indicate how intensely a sentiment is expressed in the one or more segments of primary content.

19. The method of claim 15, wherein the one or more segments of primary content are one or more of: non-fictional news coverage or fictional content.

20. The method of claim 15, further comprising causing a media device to insert the secondary content into the one or more segments of primary content.
